(19) United States
(12) Patent Application Publication
(10) Pub. No.: US 2023/0237643 A1
(43) Pub. Date: Jul. 27, 2023

(54) AUGMENTED REALITY SYSTEM WITH INTERACTIVE OVERLAY DRAWING

(71) Applicant: VIZZN INC., Rocky View County (CA)

(72) Inventors: Richard SALMON, Rocky View County (CA); Bill BORGER, Rocky View County (CA)

(21) Appl. No.: 18/100,965

(22) Filed: Jan. 24, 2023

Related U.S. Application Data
(60) Provisional application No. 63/302,540, filed on Jan. 24, 2022.

(51) Int. Cl. G06T 7/00; G06T 11/00; G06T 7/37; G06T 7/33; G06T 3/60; G06F 16/58

(52) U.S. Cl. CPC G06T 7/001; G06T 11/00; G06T 7/37; G06T 7/337; G06T 3/60; G06F 16/5866; G06T 2207/30132; G06T 2207/30184

(57) ABSTRACT

A method allows an estimator or other party to “Walk the Drawings.” An estimator can open one or more sets of drawings on a mobile device and walk those same electronic drawings as they actually walk or traverse the physical site itself. In other words, as the estimator physically moves across the construction site in the real world, their electronic icon (avatar) moves across the corresponding electronic drawings on their mobile device. Now the estimator can identify present and future such as features that need to be accessible being buried under asphalt. While walking the drawings, the estimator can label any challenges or features by simply clicking their avatar and it will post that geo-stamped location complete with corresponding notes and photos straight to the drawings for later review and analysis.

### CROSS-REFERENCE TO RELATED APPLICATIONS

This application claims the benefit of priority to U.S. provisional patent application Ser. No. 63/302,540 entitled “AUGMENTED REALITY SYSTEM WITH INTERACTIVE OVERLAY DRAWING” filed Jan. 24, 2022, hereby incorporated by reference in its entirety.

### FIELD OF THE INVENTION

The present invention pertains to augmented reality systems, and in particular to the use of augmented reality systems and method for use in construction sites.

### BACKGROUND

Estimating in the field of heavy civil construction is a high risk, high reward endeavor. A single estimating error can either lead to losses on the project or may result in not obtaining a contract at all.

Typically, an estimator goes to a construction site with a paper copy of the drawings. Drawings may include details of roads, utilities, buildings, etc. Upon arriving, the estimator attempts to translate in their minds-eye how these drawings and the actual site itself correlate. Visualizing how the drawings will translate into reality is a very difficult task. An error in this exercise can be very costly. Misinterpreting the proximity of structures, environmental challenges, the need for removal and reconstruction of roads and sidewalks, conflicts with overhead powerlines, or misunderstanding site boundaries, are just a few common estimating mistakes that happen.

Therefore, there is a need for a method and apparatus that allows an estimator to easily visualize drawing and map information from different sources that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiment of the present invention is to provide methods and apparatus that allows an estimator or other party to “Walk the Drawings.” An estimator can open one or more sets of drawings on a mobile device and walk those same electronic drawings as they actually walk or traverse the physical site itself. In other words, as the estimator physically moves across the construction site in the real world, their electronic icon (avatar) moves across the corresponding electronic drawings on their mobile device. Now the estimator can identify and locate features that may need to be accessible while being buried under asphalt. While walking the drawings, the estimator can label any challenges or features by simply clicking their avatar and it will post that geo-stamped location complete with corresponding notes and photos straight to the drawings for later review and analysis.

Embodiments may provide extended mapping feature to enable site leaders to optimally design their site layouts for optimal construction efficiency. A user can label the best locations for haul roads, access points, equipment laydown areas, material storage spots and any other job details that might improve site efficiency. Placing these details on the drawings translates into actual placement in the field and at those exactly identified locations. These mapping features can also be used to documenting extras billings, quality control or environmental challenges.

Embodiments may include project schedules that allow for unlimited sub-schedules such as embedded equipment plans, embedded crew plans or any other embedding a user can think of. Schedule data, dates, and resources may be filtered and viewable separately. As an overall schedule changes at the highest level all the embedded schedules change with it. These embedded schedules provide a holistic view of an entire site, or an entire company's resource utilization.

In accordance with embodiments of the present invention, there is provided a method for navigation. The method includes receiving, on a mobile device a terrain image and a map overlay from a server, where the terrain image and the map overlay are aligned together. Also, tracking, the movement of the mobile device as it moves within the area of the terrain image, and annotating, a position of the mobile device superimposed on the terrain image and the map overlay.

In accordance with embodiments of the present invention, there is provided a method for aligning layers on an augmented reality display. The method includes receiving, an image file, and rotating the image file to a predetermined heading. Also, selecting a plurality of reference points on a terrain image, and selecting a first alignment point in the image file corresponding to one of the plurality of reference points. Then selecting a second alignment point in the image file, where the second alignment point is located on a line connecting two of the reference points.

In accordance with embodiments of the present invention, there is provided a method for displaying annotated image data. The method includes receiving, image data. Then processing the image data into byteslist and injecting the byteslist into a native map image layer. Also, combining the native map image layer with a visual object, and rendering a map image.

In accordance with embodiments of the present invention, there is provided a method for capturing a photo. The method includes receiving a camera heading associated with a camera, then rotating a terrain image until a heading of the terrain image matches the camera heading. Also, capturing a photo with the camera, and tagging the photo with metadata to produce a tagged photo, then sending the tagged photo to a server.

In further embodiments, the camera is a component of the mobile device.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides an illustration of general infrastructure that may be used to perform the methods as described herein, according to an embodiment.

FIG. 2 provides a flow chart for methods of overlaying a layer on a site map drawing, according to an embodiment.

FIG. 3 provides a flow chart for methods of adding photos on a mobile device, according to an embodiment.

FIG. 4 provides a flow chart for methods of adding objects and image data to a render map, according to an embodiment.

FIG. 5 provides a block diagram of a computing device which may be used to implement the methods as described herein.

FIG. 6 illustrates a user interface of satellite images of a build site with reference points indicated, according to an embodiment.

FIG. 7 illustrates a user interface of map overlay of a build site with the reference points of FIG. 6 and an orientation line indicated, according to an embodiment.

It will be noted that throughout the appended drawings, like features are identified by like reference numerals.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Embodiments of the present invention provide an augmented reality computer system together with methods that allows an estimator or other party to “Walk the Drawings.” An estimator can open one or more sets of drawings on a mobile device and walk those same electronic drawings as they actually walk or traverse the physical site itself. In other words, as the estimator physically moves across the construction site in the real world, their electronic icon (avatar) moves across the corresponding electronic drawings on their mobile device. Now the estimator can identify and locate features that may need to be accessible while being buried under asphalt. While walking the drawings, the estimator can label any challenges or features by simply clicking their avatar and it will post that geo-stamped location complete with corresponding notes and photos straight to the drawings for later review and analysis.

Embodiments may provide extended mapping feature to enable site leaders to optimally design their site layouts for optimal construction efficiency. A user can label the best locations for haul roads, access points, equipment laydown areas, material storage spots and any other job details that might improve site efficiency. Placing these details on the drawings translates into actual placement in the field and at those exactly identified locations. These mapping features can also be used to documenting extras billings, quality control or environmental challenges.

Embodiments may include project schedules that allow for unlimited sub-schedules such as embedded equipment plans, embedded crew plans or any other embedding a user can think of. Schedule data, dates, and resources may be filtered and viewable separately. As an overall schedule changes at the highest level all the embedded schedules change with it. These embedded schedules provide a holistic view of an entire site, or an entire company's resource utilization.

Augmented reality systems as described in embodiments herein may be used in a number of industries and applications. Land developers and home builders may use embodiments to show how to drive a site by creating a Google Map annotated equivalent before Google Maps are actually supported in that area. A person can use the augmented reality system to drive to their lot without it being staked and understand the orientation, size, and view of key features. The shipping industry may utilize a map overlay over waterways to facilitate the travel of vessels in predefined shipping lanes or parking spots/berths, while avoiding hazards. Similarly, the airline industry may overlay runways for the pilots. Embodiments may also be used by the mining Industry to accurately overlay features, obstacles, hazards, etc. on the mine area.

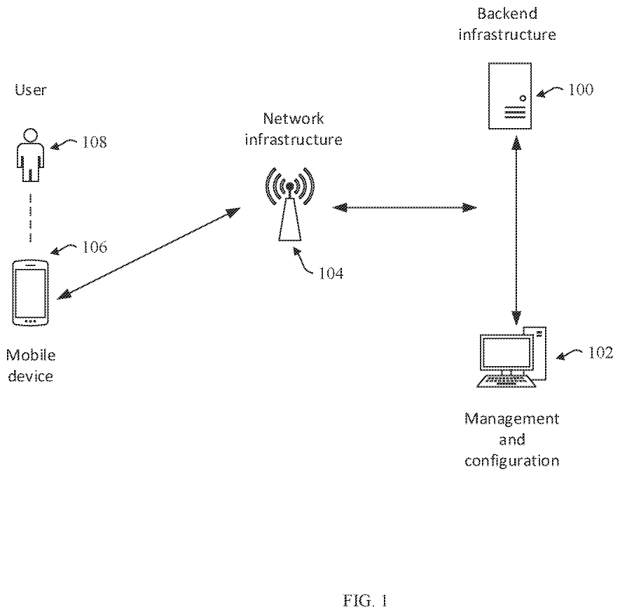

FIG. 1 illustrates an illustration of general infrastructure that may be used to perform the methods as described herein. An augmented reality software platform may be hosted on backend infrastructure 100 which may contain any number and combination of real or virtual computer servers that may be located centrally, be distributed, be part of a cloud computing service, etc. as is known in the art. One or more computers, may be used to provide management and configuration 102 to the system and perform functions such as capturing and aligning layers, processing photos and points or interest, etc. Either the backend infrastructure 100 or the management and configuration system 102 may also include databases for storage of photos, maps, layers, etc. and accompanying metadata. One or more users 108, using one or more mobile devices 106 may be deployed to the field to perform on-site functions required to produce estimates related to a build site. Each mobile device 106 may be a commonly used device such as a cell phone, smart phone, tablet, laptop computer, etc. Network infrastructure 104 may be a combination of any type of public or private wired or wireless network such as Ethernet, WiFi, cellular networks, etc. that may be used to communicate between the backend infrastructure 100, the management and configuration system 102, and mobile devices 106.

In embodiments, a user 108 may open a set of drawings or maps on their mobile device 106 and walk those same electronic drawings as they actually walk the physical site itself. In other words, as an estimator, foreman or laborer (user 108) physically moves across a construction site in the real world, their electronic icon (avatar) moves across the corresponding electronic drawings or maps that they have chosen on their mobile device 106 to view. These maps can include drawings, safety maps, underground locate maps, job construction details, material details.

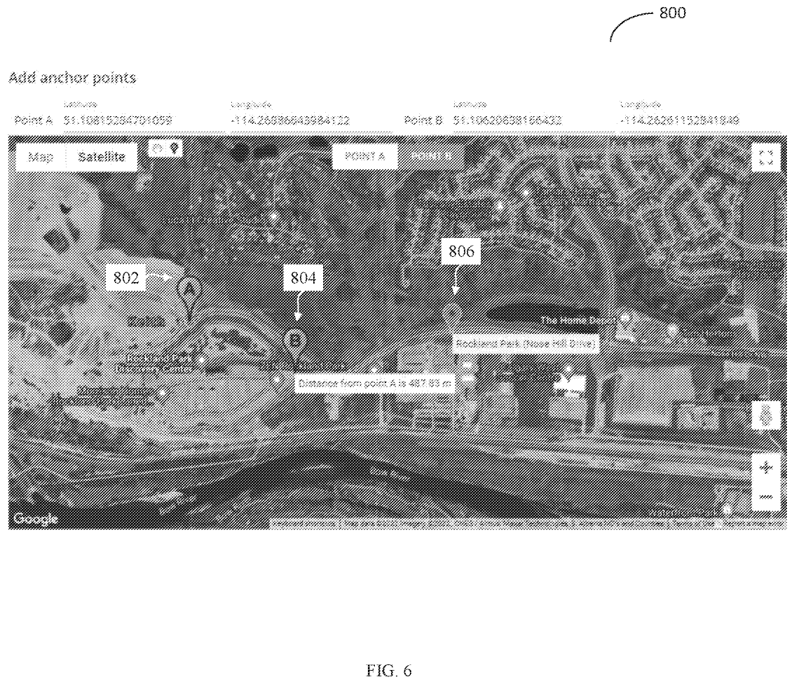

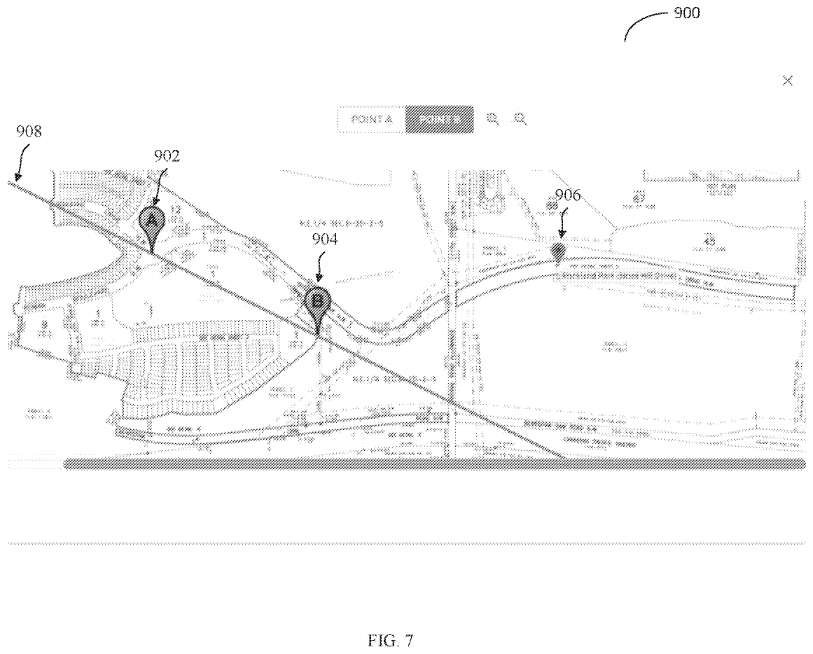

With reference to FIG. 6 and FIG. 7, layers such as maps may be overlayed in the augmented reality system using a “site builder” interface by clicking two points on the map (902 and 904) and the same two points in the real world (802 and 804). FIG. 6 shows a real world satellite image 800 of a build site while FIG. 7 shows a map overlay 900 of the same area. After picking two points in the satellite image 800 the second point on the map you are overlaying has a line 902 that shows the exact angle between the two points in the real world. This aids the user 108 in choosing the correct point on the map drawings 900.

While moving about in the construction site, a user 108, such as a construction estimator, can simultaneously see themselves as an avatar on the drawings 900 on site and see information on satellite image 800, map 900, and other layers that have been configured for the build site. Also, while walking the drawings, the user 108 can label any challenges by simply clicking their avatar and the mobile device 106 software will post that geo-stamped location complete with any corresponding notes and photos (showing the direction of the camera) straight to the shared drawings for later review and analysis. This feature can also be used to documenting extras billings, quality control or environmental challenges to name just a few use cases. Information such as notes, may entered by user 108 by typing at a keyboard or keypad, using voice-text software, adding voice recordings, etc. Other information such as absolute or relative location, bearing, altitude, azimuth, etc. may be obtained from sensors included in the mobile device 106.

Embodiments extended the “Walk the Drawings” mapping feature to enable other users, such as site leaders, to optimally design their site layouts for optimal construction efficiency. For example, a user 108 can label the best locations for haul roads, access points, equipment laydown areas, material storage spots and any other job details that might improve site efficiency. Placing these details on the drawings 900 translates into actual placement in the field 800 and at those exactly identified locations as a person delivering items can follow their avatar to the drop off spots using their own mobile device connected to the augmented reality system. In embodiments, the augmented reality system may be used to issue work orders, and if another user accepts the work order, they may be automatically added to the system for that build site. User's who are not able to access the system may be provided with static or dynamic drawings, images, maps, etc.

In embodiments, any user, that has access and permission, can label points from the field to the office or from the office to the field. Photos or video added from a phone will include metadata including GPS location data to show where that picture was taken, be geo-stamped, and may indicate the direction that the camera was pointing. These points and maps can stored, catalogued, and filtered by category for quick filtering depending on what the user requires for what they are doing and whether they are on their phone or the computer. Categories may be customizable and may include additional information such as site logistics, safety/hazard points, indicators for extra billings, quality control points, environmental, tendering, etc. System administrators may configure the system to accept, store, filter, and display any number of metadata that may be used for that particular application.

In embodiments, when looking at the drawings on the computer the transparency of layers can be adjusted to simultaneously view an informational layers as well as the underlying terrain. Tools may be added to allow a user to perform absolute or relative measurements of distance, height, angle, etc. between points or other references.

In embodiments, locations may be indicated such a spill piles, areas to place materials or not to place materials, recommended or prohibited routes, etc. When a user enters a site, their avatar will appear on the map of the area and locations may be viewed with the user's avatar indicated. For example, if a driver arrives to deliver gravel, through a dispatch received through the augmented reality system, they may access the system to see their location and where they should deliver the gravel to. The driver may access the system through a user interface, such as by clicking an icon to access the build site or through automatically detecting the driver's location. The system may indicate directions to the destination or launch a GPS program to direct the driver. Maps may be rotated so that the driver's direction of travel is in front of them to make for easier navigation and may alert the driver when they reach their destination and provide additional information on how and where the gravel should be placed.

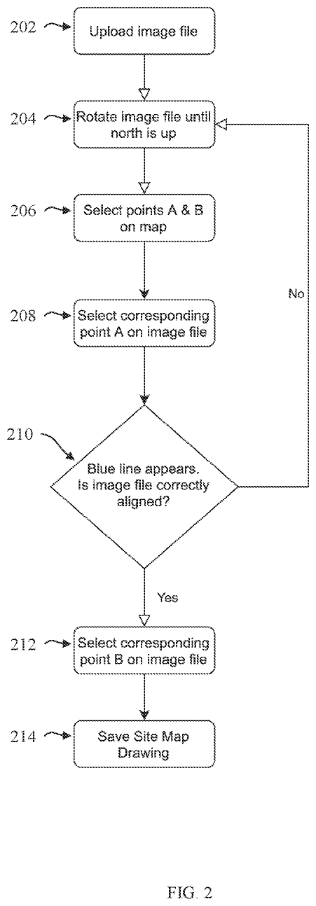

FIG. 2 provides a flow chart for methods of overlaying a layer on a site map drawing, according to an embodiment. In step 202 an image file containing the image overlay, such as image 900, is uploaded. In step 204 the image file is rotated to a predetermined orientation, such as rotating the image until north is up. In step 206, a user selects two reference points, A 802, and B 804 on the terrain map 800. In step 208, the user selects corresponding alignment point A 902 on the image file of the overlay 900. In step 210, the system displays a line 908 (drawn in a visible colour such as blue) through point A 902 and the user confirms if the image file is aligned correctly. If not aligned correctly, the method returns to step 204 to adjust the rotation of the image file. If aligned correctly, in step 212, the user selects the corresponding alignment point B 904 in the image file. In step 214, the site map drawing 900 is saved within the system.

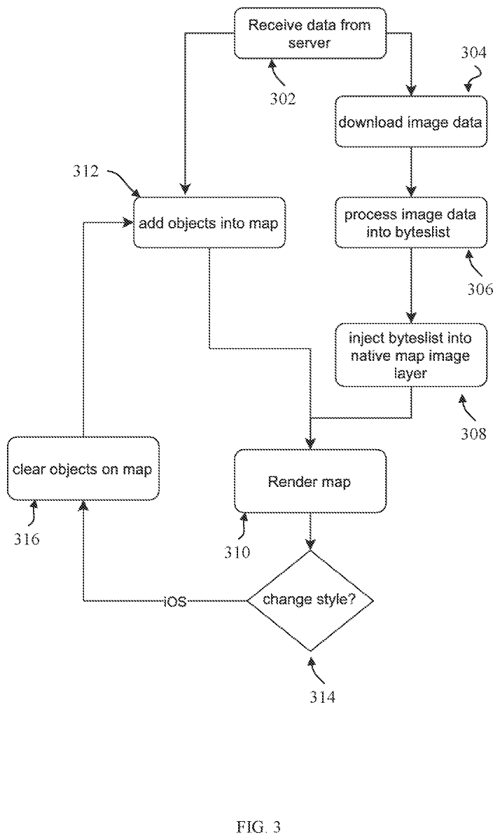

FIG. 3 provides a flow chart for methods of adding photos on a mobile device 106, according to an embodiment. In step 302, the mobile device 106 receives data from a server of backend infrastructure 100. In step 304, the image data is downloaded, and in step 306 the image data is processed into a byteslist. In step 308 the byteslist is injected into a native map image layer. In step 312 objects may be added into a map of the area allowing the map to be rendered in step 310. In step 314, a decision may be made to change the style of the map in order to better present the drawings on the mobile device. In step 316 objects may be cleared from the map before adding objects into the map in step 312.

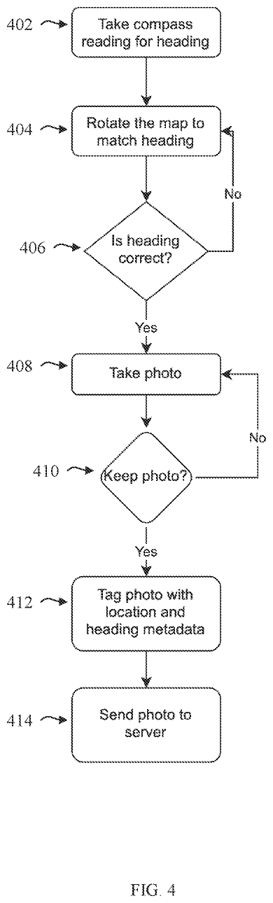

FIG. 4 provides a flow chart for methods of adding objects and image data to a render map, according to an embodiment. The method of FIG. 4 may be used when taking photos in the field on a mobile device 106. In step 402, a compass reading may be read from sensors in the mobile device 106 and used to determine a heading. In step 404, the terrain map may be rotated to match the heading, thereby aligning the mobile device with the physical build site. In step 406, it is verified that the heading is correct, and if not, the method returns to step 402. In step 408, the photo is taken, and in step 410, it is determined that the photo may be used. In step 412, the photo may be tagged with various metadata such as location and the heading of the camera of the mobile device. In step 414, the photo may be sent to the server in backend infrastructure 100.

Embodiments may provide enhancements to traditional project management software, including a macro scheduler with sub-schedules that move as the higher level schedule changes. In the case of a construction site, this could be a job schedule at its highest level similar to schedules supported by software such as Microsoft Project. Embodiments may improve on this by allowing for unlimited sub-schedules such as embedded equipment plans, embedded crew plans, or any other required embedded information. Sub-schedules may be filtered using different criteria and viewable separately. Examples of filtering criteria are duration, dates, milestones, equipment, location, crew, other resources, etc. As the overall schedule changes at the highest level all the embedded schedules change with it. These embedded schedules provide a holistic view of the entire company's resource utilization.

As an example, using embodiments of the augmented reality system described herein, an equipment sub-schedule (equipment) may show the actual available fleet available on any date and compare that to the aggregated projected equipment demands. This scheduler can include a specific equipment or a type of equipment (example unit #1 or “large backhoe”). Embodiments may take into consideration factors such as equipment out of service, under repair or to be rented out at a future date. As the job schedules change or the equipment fleet changes, the equipment schedule may change with it, keeping the information related to equipment demands and availability up to date and relevant. Being able to see equipment demands for each type of equipment well in advance helps companies make better decisions around renting vs. buying equipment, selling vs. repairing equipment, and choosing rental terms for hourly vs. monthly, or even moving projects around.

Embodiments may include a user interface that may be used by methods of adding equipment, or other resources, to a project. Embodiments may also include a user interface that shows a holistic view of equipment, or other resources, and how they may move to illustrate schedule changes.

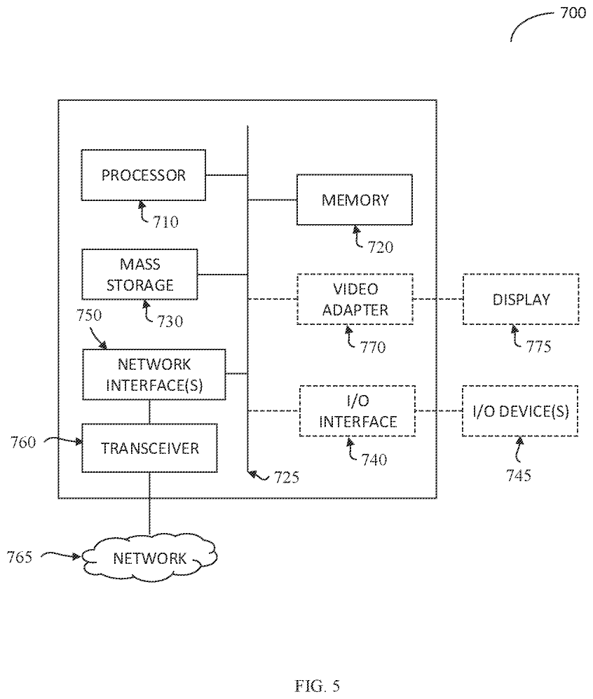

FIG. 5 is a schematic diagram of an electronic device 700 that may perform any or all of operations of the above methods and features explicitly or implicitly described herein, according to different embodiments of the present invention. For example, a mobile computing device, a physical or virtual computer or server may be configured as computing device 700.

As shown, the device includes a processor 710, such as a central processing unit (CPU) or specialized processors such as a graphics processing unit (GPU) or other such processor unit, memory 720, non-transitory mass storage 730, I/O interface 740, network interface 750, video adaptor 770, and any required transceivers 760, all of which are communicatively coupled via bi-bus 725. Video adapter 770 may be connected to one or more of display 775 and I/O interface 740 may be connected to one or more of I/O device 745 which may be used to implement a user interface. According to certain embodiments, any or all of the depicted elements may be utilized, or only a subset of the elements. Further, computing devices 700 may contain multiple instances of certain elements, such as multiple processors, memories, or transceivers. Also, elements of the hardware device may be directly coupled to other elements without the bus 725. Additionally, or alternatively to a processor and memory, other electronics, such as integrated circuits, may be employed for performing the required logical operations.

The memory 720 may include any type of non-transitory memory such as static random access memory (SRAM), dynamic random access memory (DRAM), synchronous DRAM (SDRAM), read-only memory (ROM), any combination of such, or the like. The mass storage element 530 may include any type of non-transitory storage device, such as a solid state drive, hard disk drive, a magnetic disk drive, an optical disk drive, USB drive, or any computer program product configured to store data and machine executable program code. According to certain embodiments, the memory 720 or mass storage 730 may have recorded thereon statements and instructions executable by the processor 710 for performing any of the aforementioned method operations described above.

It will be appreciated that it is within the scope of the technology to provide a computer program product or program element, or a program storage or memory device such as a magnetic or optical wire, tape or disc, USB stick, file, or the like, for storing signals readable by a machine, for controlling the operation of a computer according to the method of the technology and/or to structure some or all of its components in accordance with the system of the technology. Acts associated with the method described herein can be implemented as coded instructions in a computer program product. In other words, the computer program product is a computer-readable medium upon which software code is recorded to execute the method when the computer program product is loaded into memory and executed on the microprocessor of computing devices.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

What is claimed is:

1. A method for navigation comprising:
receiving, on a mobile device a terrain image and a map overlay from a server, the terrain image and the map overlay aligned;
tracking, the movement of the mobile device as it moves within the area of the terrain image; and
annotating, a position of the mobile device superimposed on the terrain image and the map overlay.

2. A method for aligning layers on an augmented reality display, the method comprising:
receiving, an image file;
rotating the image file to a predetermined heading;
selecting a plurality of reference points on a terrain image;
selecting a first alignment point in the image file corresponding to one of the plurality of reference points; and
selecting a second alignment point in the image file, the second alignment point located on a line connecting two of the reference points.

3. A method for displaying annotated image data, the method comprising:
receiving, image data;
processing the image data into a byteslist;
injecting the byteslist into a native map image layer;
combining the native map image layer with a visual object; and
rendering a map image.

4. The method of claim 1 further comprising:
receiving a camera heading associated with a camera;
rotating the terrain image until a heading of the terrain image matches the camera heading;
capturing a photo with the camera;
tagging the photo with metadata to produce a tagged photo; and
sending the tagged photo to a second server.

5. The method of claim 4 wherein the camera is a component of the mobile device.
